(19) United States
(12) Patent Application Publication
(10) Pub. No.: US 2024/0128580 A1
(43) Pub. Date: Apr. 18, 2024

(54) VEHICLE BATTERY PACK INCLUDING A THERMAL MANAGEMENT ASSEMBLY

(71) Applicant: Ford Global Technologies, LLC, Dearborn, MI (US)

(72) Inventors: Bin Yin, NanJing (CN); Steven Shi, NanJing (CN); Jim Liu, Nanjing (CN)

(21) Appl. No.: 18/481,431

(22) Filed: Oct. 5, 2023

(30) Foreign Application Priority Data
Oct. 14, 2022 (CN) 2022112629470

(51) Int. Cl. H01M 50/291; H01M 10/613; H01M 10/625; H01M 10/6556; H01M 50/209; H01M 50/249; H01M 50/264; H01M 50/293; H01M 50/505

(52) U.S. Cl. CPC H01M 50/291; H01M 10/613; H01M 10/625; H01M 10/6556; H01M 50/209; H01M 50/249; H01M 50/264; H01M 50/293; H01M 50/505; H01M 2220/20

(57) ABSTRACT

A vehicle battery pack includes several supporting beams extending in a first direction; and battery modules located between the supporting beams. The battery module comprises: a base plate extending in the first direction; multiple battery cells arranged in a stacked manner and placed on the base plate; and end plates connected to the base plate, the end plates compress the multiple battery cells from both sides in the first direction. The battery cell has end faces facing a second direction and the end faces are adjacent to the supporting beams. A vehicle can include the aforementioned vehicle battery pack.

### CROSS-REFERENCE TO RELATED DISCLOSURES

This disclosure claims priority to Chinese Patent Disclosure No. 2022112629470, which was filed on 14 Oct. 2022 and is incorporated herein by reference in its entirety.

### TECHNICAL FIELD

The present disclosure generally relates to the field of vehicle batteries, and more specifically, to a vehicle battery pack and a corresponding vehicle.

### BACKGROUND

Electric vehicles differ from conventional motor vehicles in that they are selectively driven by one or more electric machines powered by traction batteries. The electric machines can drive the electric vehicles instead of, or in addition to, an internal combustion engines. Examples of electric vehicles include hybrid electric vehicles (HEVs), plug-in hybrid electric vehicles (PHEVs), fuel cell vehicles (FCVs), and battery electric vehicles (BEVs).

With the increasing demand for electricity in modern motor vehicles, such as the increasing demand for vehicle electricity caused by an increase in mileage demand and the number of various electrical devices in the vehicle, vehicle battery packs used to provide electricity for the vehicle also occupy an increasing amount of vehicle space and have a more complex structure. In known vehicle battery packs, several battery cells are usually encapsulated into battery modules through closed plates such as base plates, side plates, and end plates, and several battery modules are further arranged horizontally and vertically in a frame of the battery pack to form the vehicle battery pack.

### SUMMARY

The present disclosure summarizes aspects of the embodiments and should not be used to limit the claims. Other implementations are contemplated in accordance with the techniques described herein, as will be apparent to those skilled in the art upon examination of the following drawings and detailed description, and such implementations are intended to be within the scope of this application.

According to an aspect of the present disclosure, a vehicle battery pack is provided, comprising, several supporting beams extending in a first direction, and battery modules located between the supporting beams. The battery module include a base plate extending in the first direction multiple battery cells arranged in a stacked manner and placed on the base plate, and end plates connected to the base plate, the end plates compress the multiple battery cells from both sides in the first direction. The battery cell has end faces facing a second direction and the end faces are adjacent to the supporting beams.

According to an embodiment of the present disclosure, the battery cell has a pair of side faces facing the first direction and a pair of end faces facing the second direction, wherein the multiple battery cells are arranged on the base plate with their side faces facing each other, and the end faces are directly facing the supporting beams, and wherein the side face has an area larger than the end face.

According to an embodiment of the present disclosure, the first direction is a transverse direction of the battery pack, the second direction is a longitudinal direction of the battery pack, and the base plate extends throughout the entire battery pack along the first direction.

According to an embodiment of the present disclosure, the supporting beam comprises wing plates protruding from bottom to sides, the base plate is supported on the wing plate, and the end plate and the base plate are fixed to the wing plate of the supporting beam.

According to an embodiment of the present disclosure, the battery module further comprises module fasteners, the end plate comprises through-holes that run from top to bottom, and the module fastener is fixed to the wing plate of the supporting beam after passing through the through-hole and the base plate.

According to an embodiment of the present disclosure, the base plate is connected to bottom sides of the battery cells through adhesive.

According to an embodiment of the present disclosure, the base plate comprises a coolant circuit and an inlet and outlet connected to the coolant circuit.

According to an embodiment of the present disclosure, the base plate comprises support edges supported on the supporting beams, and the coolant circuit is distributed on a lower side of the base plate between the support edges.

According to an embodiment of the present disclosure, the inlet and outlet are located on the same side of the base plate.

According to an embodiment of the present disclosure, the base plate has side edges facing the supporting beams, the side edge has a local thickening area.

According to an embodiment of the present disclosure, an elastic material cushion is arranged between the battery cells.

According to an embodiment of the present disclosure, the elastic material cushion is a thin layer of foam.

According to an embodiment of the present disclosure, a battery cell bus connected to the multiple battery cells and the end plate from an upper side.

According to an embodiment of the present disclosure, there is a gap between the supporting beam and the end face of the battery cell facing the second direction.

According to an embodiment of the present disclosure, the supporting beam and the end face of the battery cell facing the second direction are connected by adhesive.

According to an embodiment of the present disclosure, further comprising supporting side beams located on both sides, and the supporting beams are respectively connected to the supporting side beams.

According to another aspect of the present disclosure, a vehicle battery pack is provided, comprising several supporting beams extending in a first direction throughout the battery pack; and battery modules located between the supporting beams. The battery module includes a base plate extending in the first direction throughout the battery pack, wherein the base plate includes a coolant circuit, multiple battery cells with their side faces arranged relative to each other and connected to the base plate through adhesive, and end plates connected to the base plate, the end plates compressing the multiple battery cells from both sides in the first direction. The battery cell has end faces facing a second direction and the end faces are adjacent to the supporting beams.

According to an embodiment of the present disclosure, the supporting beam comprises wing plates protruding from bottom to sides, and the base plate is supported on the wing plate.

According to an embodiment of the present disclosure, the supporting beam and the end face of the battery cell facing the second direction are connected by adhesive.

According to yet another aspect of the present disclosure, a vehicle, including a vehicle battery pack as described in any of the above embodiments, is provided.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

For a better understanding of the present disclosure, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further in the figures, like reference numbers refer to like parts throughout the different figures.

FIG. 1 shows a schematic diagram of a vehicle including a vehicle battery pack according to one or more embodiments of the present disclosure;

FIG. 2 shows a top view of the vehicle battery pack according to one or more embodiments of the present disclosure;

FIG. 3 shows a perspective view of a portion of the vehicle battery pack according to one or more embodiments of the present disclosure, including a battery module and supporting beams on both sides;

FIG. 4 shows a side view of the aforementioned portion of the vehicle battery pack according to one or more embodiments of the present disclosure;

FIG. 5 shows an end view of the aforementioned portion of the vehicle battery pack according to one or more embodiments of the present disclosure;

FIG. 6 shows a bottom view of the aforementioned portion of the vehicle battery pack according to one or more embodiments of the present disclosure;

FIG. 7 shows a top view of the aforementioned portion of the vehicle battery pack according to one or more embodiments of the present disclosure;

FIG. 8 shows a cross-sectional view in X direction of the aforementioned portion of the vehicle battery pack according to one or more embodiments of the present disclosure;

FIG. 9 shows a top view of a base plate of the vehicle battery pack according to one or more embodiments of the present disclosure; and

FIG. 10 shows a cross-sectional view of the base plate of the vehicle battery pack according to one or more embodiments of the present disclosure, taken along A-A′ in FIG. 9.

### DETAILED DESCRIPTION

Embodiments of the present disclosure are described below. However, it is to be understood that the disclosed embodiments are merely examples and other embodiments may take various and alternative forms. The figures are not necessarily to scale. Some features may be exaggerated or minimized to show details of particular components. Therefore, specific structural and functional details disclosed herein are not to be interpreted as limiting, but merely as a representative basis for teaching one skilled in the art to variously employ the present disclosure. As will be understood by those of ordinary skill in the art, various features shown and described with reference to any one figure may be combined with features shown in one or more other figures to produce embodiments not expressly shown or described. The combinations of features shown herein provide representative embodiments for typical disclosures. However, various combinations and modifications of the features consistent with the teachings of the present disclosure may be desired for certain particular applications or implementations.

In this document, when an element or part is referred to as being “on . . . ”, “bonded to”, “connected to”, or “coupled to” another element or part, the element or part can be directly on another element or part, can be bonded, connected or coupled to another element or part, or there may be intervening elements or parts. In contrast, when an element is referred to as being “directly on . . . ”, “directly bonded to”, “directly connected to”, or “directly coupled to” another element or part, the intervening elements or parts may not be present. Other words used to describe the relationship between elements should be interpreted in a like fashion.

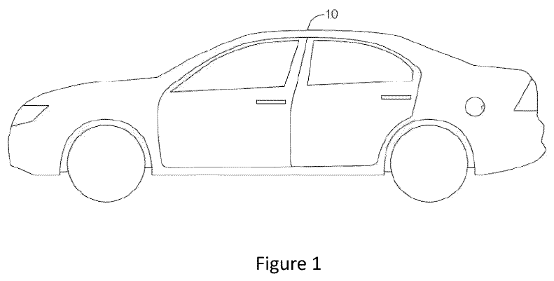

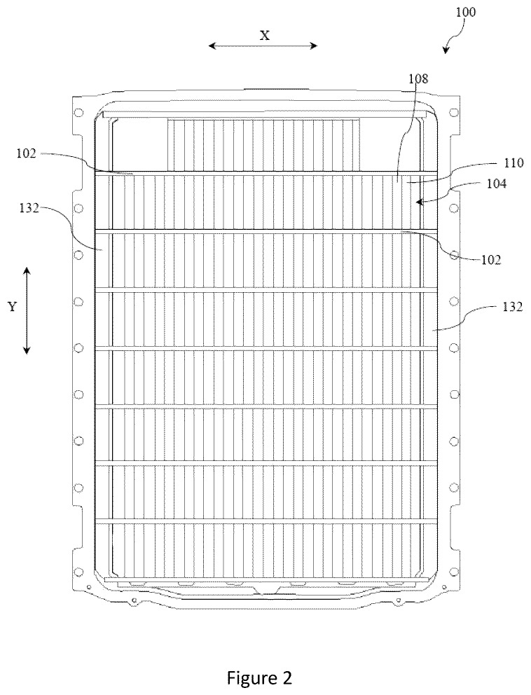

With reference to FIGS. 1 and 2, a vehicle 10 includes a vehicle battery pack 100 according to one or more embodiments of the present disclosure. It should be understood that in the context of the present disclosure, the vehicle 10 implementing the present disclosure can refer to any means of transportation including a vehicle battery pack, such as but not limited to fossil fuel vehicles, electric vehicles (such as plug-in hybrid electric vehicles (PHEVs), fully hybrid electric vehicles (FHEVs), mild hybrid electric vehicles (MHEVs) or battery electric vehicles (BEVs), and even ships, aircrafts, etc. The vehicle can include components related to mobility, such as engine, electric motor, transmission, suspension, drive shaft, and/or wheels. The vehicle 10 can be non-autonomous, semi-autonomous (for example, some conventional motion functions are controlled independently by the vehicle) or autonomous (for example, motion functions are controlled independently by the vehicle without direct input from user).

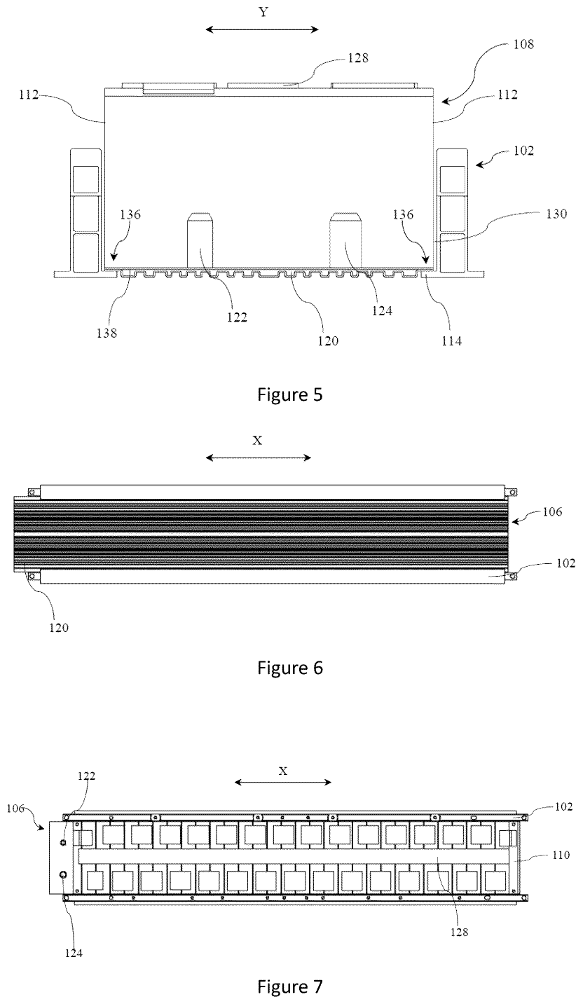

Regarding the aforementioned technical issue, an aspect of the present disclosure generally provides a vehicle battery pack 100, as shown in FIGS. 2 to 10 as a whole. The vehicle battery pack 100 includes several supporting beams 102 and battery modules 104 located between the supporting beams 102, wherein the supporting beams 102 extend in a first direction X. The battery module 104 further includes a base plate 106, end plates 110 connected to the base plate 106, and multiple battery cells 108 located between the end plates 110. The base plate 106 also extends along the first direction X, the multiple battery cells 108 are facing each other with their side faces, stacked in rows, and placed on the base plate 106. In this illustrative embodiment, the base plate 106 can extend in the first direction and run through a transverse direction of the entire battery pack 100. The entire battery pack 100 can include multiple base plates 106 arranged in a Y direction. In this way, many battery cells 108 can be compactly arranged throughout the transverse direction of the battery pack 100, further enhancing capacity. The end plates 110 are located on both sides of the aforementioned multiple battery cells 108 in the first direction X and compress the multiple battery cells 108 along the first direction X. Wherein, referring to the end view in FIG. 5, the battery cell 108 has end faces 112 facing the second direction Y and the end faces 112 are adjacent to the supporting beams 102. In one or more embodiments, the battery cell 108 has a pair of opposite side faces in the first direction X and a pair of opposite end faces 112 in the second direction Y, wherein the multiple battery cells 108 are arranged on the base plate 106 with their side faces facing each other, and the end faces 112 are directly facing the supporting beams 102, in other words, the end faces 112 are adjacent to the supporting beams 102. In some embodiments, the side face of the battery cell 108 has an area larger than the end face 112. In this way, applying pressure to the larger side face of the battery cell 108 can make the force area larger and the structure more stable. It should be pointed out that the “adjacent” of two objects referenced in the present disclosure should be understood as that the two objects come into direct contact or come into contact with each other through connection means (such as bonding), or there is a gap between the two, in the case of a gap, in addition to the possible medium (such as air), there should be no other object between the two, such as there may be an air gap between the end face 112 and the supporting beam 102, or the end face 112 and the supporting beam 102 may also be in contact with each other.

In the context of the present disclosure, the first direction X and the second direction Y are different directions and they form an angle, for example, but not limited to around 90 degrees. In the embodiment of FIG. 2, the first direction X is generally the transverse direction of the vehicle, or referred to as a battery pack transverse direction (i.e. the approximate transverse direction of the battery pack after installation on the vehicle). The second direction Y is generally a longitudinal direction of the vehicle, or referred to as a battery pack longitudinal direction (i.e. the approximate longitudinal direction of the battery pack after installation on the vehicle). In addition, the vehicle battery pack 100 can generally include, for example, around 8 to 10 supporting beams 102, which run through the battery pack 100 and are connected to an outer structural frame of the battery pack. One battery module 104 is installed between each two adjacent supporting beams 102. Through supporting beam arrangement, the overall structural strength of the vehicle battery pack 100 can be increased. Of course, it is not limited to this. Those skilled in the art can make adaptive adjustments to the first and second directions X and Y, as well as the number and layout of the supporting beams 102, as needed. The number of battery modules 104 and the number of the battery cells 108 in each battery module 104 can also be adjusted according to actual needs. The base plate 106 and the battery cells 108 on it can generally extend to the full length or a part of the full length of the supporting beam 102. In the embodiment of the present disclosure, each supporting beam 102 is connected to a battery pack frame structure and can simultaneously position and support the battery modules located on both sides, without the need for the battery modules to be equipped with additional independent two module side plates. By eliminating the side plates of battery cell 108 and replacing them with the supporting beams 102, the overall structure of the battery cell 108 and the vehicle battery pack 100 can be simplified to a certain extent, while reducing weight and simplifying assembly. At the same time, the compact structure also reduces system volume, and facilitates system adaptability.

Continuing to refer to FIG. 2, the vehicle battery pack 100 can also include supporting side beams 132 located on both sides of the vehicle battery pack 100, and the supporting beams 102 are respectively connected to the supporting side beams 132. For example, each supporting beam 102 is supported and connected to the supporting side beams 132 through its two ends, thereby further improving the overall structural strength of the vehicle battery pack 100. Those skilled in the art can understand that the connection between the supporting beams 102 and the supporting side beams 132 can be achieved through known connection methods, such as welding, fastener connection, integrated molding, and so on. Furthermore, in addition to the supporting beams 102 and the supporting side beams 132, the vehicle battery pack 100 can further include other supporting/protective structures, such as supporting longitudinal beams, battery pack tray, upper cover, etc., which will not be further described in this disclosure.

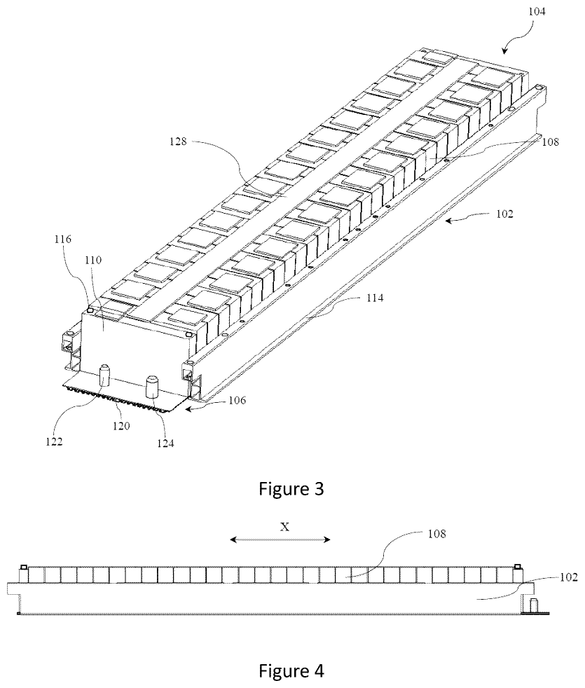

Referring to the perspective view in FIG. 3 and the end view in FIG. 5, the supporting beam 102 can include wing plates 114 protruding from its bottom to both sides—generally towards the direction of the battery module 104, so that the cross-sectional area of the supporting beam 102 is generally “inverted T-shaped”. The base plate 106 is supported on the wing plates 114 of the supporting beams 102 on both sides through support edges 136 on both sides, as shown in FIG. 10. Based on this, it can be achieved to provide better support for the battery module 104 through the supporting beam 102, thereby improving the overall structural strength of the vehicle battery pack 100. In addition, in order to reduce weight and assembly complexity, the supporting beam 102 can be of a hollow design and can include several reinforced rib plates internally.

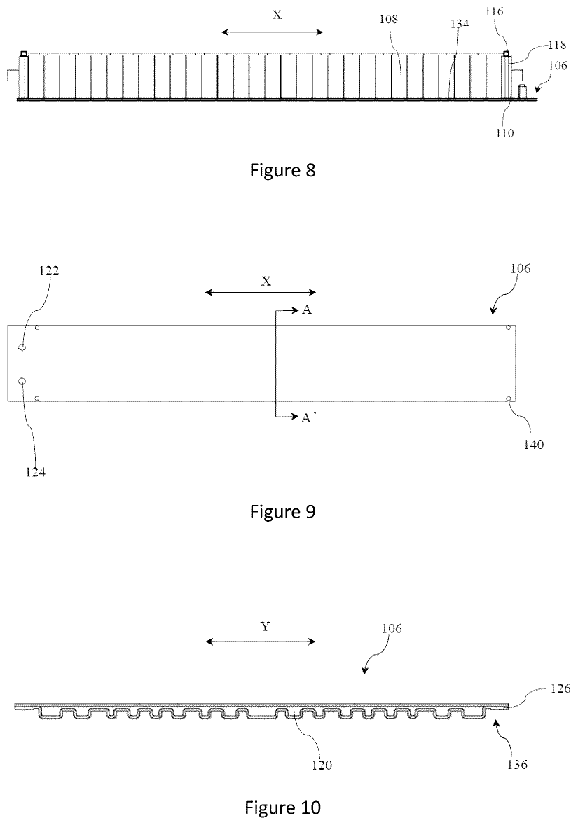

Furthermore, the end plates 110 and the base plate 106 can be fixed to the supporting beam 102 or its wing plates 114 to increase the overall structural strength. It can also be understood that the connection between the end plates 110, the base plate 106, and the supporting beams 102 can be achieved through known connection methods, such as welding, clamping, bolt connection, etc. Referring again to the perspective view in FIG. 3 and the cross-sectional view along the X direction in FIG. 8, the battery module 104 can further include module fasteners 116, the end plate 110 includes through-holes 118 that run from top to bottom, the base plate 106 includes corresponding installation holes 140, the module fastener 116 is fixed to the supporting beam 102 after passing through the through-holes 118 and the installation hole 140 on the base plate 106. The combination of the module fasteners 116 and the through-holes 118 on the end plates 110 can provide better fixation for the end plates 110 and enable the end plates 110 to provide sufficient compression force to the battery cell 108 located between the two end plates 110.

Next, referring to the end view in FIG. 5, the bottom view in FIG. 6, and the top view of the base plate in FIG. 9, the base plate 106 can include a coolant circuit 120, an inlet 122, and an outlet 124, wherein the inlet 122 and the outlet 124 are fluidly connected to the coolant circuit 120, forming an overall closed cooling channel. Fluid cooling medium can flow into the coolant circuit 120 through the inlet 122, circulate in the coolant circuit 120 and carry away heat generated by the battery cell 108 in contact with the base plate 106 during operation, and finally flow out through the outlet 124. Subsequently, the fluid cooling medium can be cooled in another radiator (not shown) and circulated back to the inlet 122, and then into the coolant circuit 120. Each battery module 104 corresponds to one separate base plate 106, and therefore one separate coolant circuit 120. This allows the vehicle 10 to independently control heat dissipation for each battery module 104, such as selectively opening or closing the coolant circuits 120 of different battery modules 104, controlling flow rate of cooling medium in the coolant circuits 120 of different battery modules 104, and so on. This enables a more targeted cooling strategy for the battery pack. It can be understood that in order to achieve corresponding control strategies, each battery module 104 can further have corresponding control valves, sensors, and other control or information collection components, which can further communicate with and be controlled by an onboard computer system.

Referring back to FIGS. 3 and 4, the inlet 122 and the outlet 124 can be located on the same end side of the base plate 106 to minimize the use of space of the base plate 106 in the first direction X. Of course, those skilled in this field can understand that different layouts can be adopted according to needs, such as placing the inlet 122 and the outlet 124 at both ends of the base plate 106, respectively.

Referring again to FIGS. 5 and 6, the coolant circuit 120 can be a channel (such as a tubular metal channel) coiled on a lower side 138 of the base plate 106 and protruding downwards from the lower side 138 of the base plate 106. The coolant circuit 120 can be, for example, but not limited to, coiled into longitudinal/transverse parallel S-shaped, helical, zigzag, etc. In addition, the tubular metal channel can be connected to the base plate 106 through welding, bonding, integrated molding, and other means. Furthermore, the base plate 106 supported on the wing plate 114 of the supporting beam 102 may not include the coolant circuit 120 at the support edges 136, and the coolant circuit 120 is only distributed on the lower side 138 of the base plate 106 between the support edges 136 to utilize the heat dissipation effect of the supporting beam 102 and the wing plates 114 and fully utilize the space between the wing plates 114.

Referring to the cross-sectional view of the base plate in FIG. 10, the side edge of the base plate 106 towards the supporting beam 102, that is, part or all of the support edge 136, may have a local thickening area 126, for example, locally thickened by 0.5-1.5 mm here, to enhance the support force of the base plate 106 on the battery cell 108. It should be understood that the local thickening area 126 can extend all or part of the length of the base plate 106 in the first direction X, and its own width and thickness can also be adjusted as needed.

Referring again to FIG. 8, a bottom side 134 of the battery cell 108 (i.e. the side facing the base plate 106) is connected to the base plate 106 through adhesives such as structural adhesive, thermal conductive adhesive, or structural thermal conductive adhesive, to increase overall structural strength and facilitate heat dissipation from the battery cell 108 to the coolant circuit 120 on the base plate 106. In addition, in some embodiments, an elastic material cushion, such as a thin layer of foam, can be arranged between adjacent battery cells 108 to accommodate certain volume changes of the battery cells 108 in both working and non-working states.

Returning to the perspective view in FIG. 3 and the top view in FIG. 7, the battery module 104 of the vehicle battery pack 100 can also include a battery cell bus 128, which is located on an upper side of the battery module 104 and connected to multiple battery cells 108 and end plates 110 at both ends. Those skilled in the art can understand that the battery cell bus 128 can be electrically connected to each battery cell 108 and connected to the end plates 110 on both sides through welding, bonding, fastener connections, and other means. The battery cell bus 128 can collect current from each battery cell 108 to provide power to electric motors (not shown) and various vehicle electrical appliances. In addition, the connection of the battery cell bus 128 to the end plate 110 can also provide a certain degree of retention force for the compression of the end plate 110 on the battery cell 108 from the upper side, further improving the overall structural strength and stability.

Referring to FIG. 5 again, there can be a gap 130 between the supporting beam 102 and the end face 112 of the battery cell 108 facing the second direction, to facilitate the installation and subsequent maintenance of the battery pack. In further embodiments, the supporting beam 102 and the end face 112 can be connected through adhesive. The adhesive can be, for example, structural adhesive, thermal conductive adhesive, or structural thermal conductive adhesive, which can increase the overall structural strength and support the heat dissipation of the battery cell 108 through the supporting beam 102 and the supporting side beams 132 on both sides, to some extent improving the overall performance and thermal management effect of the battery pack.

Those skilled in the art can understand that manufacturing materials for various components of the vehicle battery pack 100, including the supporting beam 102, support side beam 132, base plate 106, and end plate 110 mentioned above and below, may include but are not limited to various models of aluminum alloy, magnesium alloy, various low-, medium-, and high-carbon steel, and any other metal/non-metallic or synthetic materials; furthermore, the processing and manufacturing of various components of the vehicle battery pack 100 mentioned above can be achieved through methods such as but not limited to extrusion, stamping, casting, molding, 3D printing, etc. In addition, the joints or connections mentioned above or below can be achieved through various alternative methods, such as welding, bonding, clamping, riveting, threaded connection, integrated forming, etc. The welding can include, for example, but not limited to, inert gas shielded welding, etc.

In addition, in the production and subsequent maintenance of the battery pack, the assembly of the vehicle battery pack 100 can include some or all of the following steps, such as placing the base plate 106 and placing the end plate 110 on one side of the base plate 106; arranging the battery cells 108 tightly one by one on the base plate 106 and applying adhesive between the battery cells 108 and the base plate 106; after placing all battery cells 108, placing the other end plate 110 on the other side of the base plate 106; applying compression force (such as 1500-5000 N) to the end plates 110 on both sides through the tooling; placing the battery module 104 compressed by the tooling between the supporting beams 102; inserting the module fasteners 116 through the through-holes 118 on the end plate 110 and the installation holes 140 on the base plate 106 and securing them to the supporting beams 102; applying adhesive between the supporting beams 102 and the battery cells 108; finally, connecting the battery cell bus 128 from the upper side to each battery cell 108 and the end plates 110 on both sides.

According to another aspect of the present disclosure, a vehicle battery pack is also provided, comprising several supporting beams 102 extending along a first direction X throughout the vehicle battery pack, and battery modules 104 located between the supporting beams 102. The battery module 104 includes a base plate 106 extending along the first direction X throughout the vehicle battery pack, end plates 110 connected to the base plate 106, and multiple battery cells 108. The base plate 106 is supported on the supporting beams 102 and includes a coolant circuit 120. Side faces of the multiple battery cells 108 are arranged relative to each other and connected to the base plate 106 through adhesive. The end plates 110 compress the multiple battery cells 108 from both sides in the first direction X. Wherein, the battery cell 108 has end faces 112 facing a second direction Y and the end faces 112 are adjacent to the supporting beams 102. It should be further understood that all the embodiments, features, and advantages described above for the vehicle battery pack 100 according to the first aspect of the present disclosure are equally applicable to the vehicle battery pack according to the other aspect of the present disclosure, provided that they do not conflict with each other. That is to say, all embodiments and their variations mentioned above can be directly applied and combined with them. For the sake of brevity in this disclosure, it will not be repeated here.

According to yet another aspect of the present disclosure, a vehicle 10, including a vehicle battery pack as described in any of the aforementioned embodiments, is also provided. Similarly, all the embodiments, features, and advantages described above for the vehicle battery pack according to the present disclosure are equally applicable to the vehicle 10 according to the present disclosure, and will not be repeated here.

In summary, compared to the prior art, the present disclosure proposes a vehicle battery pack and a corresponding vehicle. Compared to the vehicle battery pack in the prior art, the proposed battery pack can simplify the overall structure, reduce weight and assembly complexity, and at the same time further enhance the overall performance and thermal management effect of the battery pack, thereby increasing user satisfaction.

The technical aspects of the present disclosure can simplify the overall structure of the vehicle battery pack, reduce weight and assembly complexity, and at the same time further enhance the overall performance and thermal management effect of the battery pack, thereby increasing user satisfaction.

It should be understood that, on the premise of technical feasibility, the technical features listed above for different embodiments can be combined with each other to form other embodiments within the scope of the present disclosure.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A vehicle battery pack, comprising:
a plurality of supporting beams extending in a first direction within a battery pack; and
a plurality of battery modules located between the plurality of supporting beams, each battery module within the plurality of battery modules including:
a base plate extending in the first direction;
a plurality of battery cells arranged in a stacked manner and placed on the base plate; and
a plurality of end plates connected to the base plate, the plurality of end plates compressing the plurality of battery cells from both sides in the first direction, the battery cells within the plurality of battery cells each having end faces facing a second direction that is different than the first direction, the end faces each adjacent to one of the supporting beams within the plurality of supporting beams.

2. The vehicle battery pack according to claim 1, wherein each battery cell within the plurality of battery cells has a pair of side faces facing in the first direction and a pair of the end faces facing in the second direction, wherein the plurality of battery cells are arranged on the base plate with the side faces facing each other, and the pair of end faces directly facing respective supporting beams, and wherein the side faces each have has an area larger than one of the end faces.

3. The vehicle battery pack according to claim 1, wherein the first direction is a transverse direction of the battery pack, the second direction is a longitudinal direction of the battery pack, and the base plate extends longitudinally throughout the battery pack in the first direction.

4. The vehicle battery pack according to claim 1, wherein each supporting beam within the plurality of supporting beams comprises at least one wing plate protruding from bottom to sides, the base plate is supported on the at least one wing plate, and the plurality of end plates and the base plate are fixed to the at least one wing plate.

5. The vehicle battery pack according to claim 4, wherein the battery modules within the plurality of battery modules each further comprise module fasteners, the plurality of end plates comprising through-holes that run from top to bottom of each end plate within the plurality of end plates, and the module fastener is fixed to the at least one wing plate after passing through the through-hole and the base plate.

6. The vehicle battery pack according to claim 1, wherein the base plate is connected to bottom sides of the plurality of battery cells through adhesive.

7. The vehicle battery pack according to claim 1, wherein the base plate comprises a coolant circuit and an inlet and outlet connected to the coolant circuit.

8. The vehicle battery pack according to claim 7, wherein the base plate comprises a plurality of support edges supported on the plurality of supporting beams, and the coolant circuit is distributed on a lower side of the base plate between the plurality of support edges.

9. The vehicle battery pack according to claim 7, wherein the inlet and outlet are located on a common side of the base plate.

10. The vehicle battery pack according to claim 1, wherein the base plate has a side edge facing one of the supporting beams within the plurality of supporting beams, the side edge having a local thickening area.

11. The vehicle battery pack according to claim 1, wherein an elastic material cushion is arranged between the plurality of battery cells.

12. The vehicle battery pack according to claim 11, wherein the elastic material cushion is a layer of foam.

13. The vehicle battery pack according to claim 1, further comprising a battery cell bus connected to the plurality of battery cells and the plurality of end plates from an upper side.

14. The vehicle battery pack according to claim 1, wherein there is a gap between the plurality of supporting beams and the end faces of the plurality of battery cells facing the second direction.

15. The vehicle battery pack according to claim 1, wherein the plurality of supporting beams and the end faces of the plurality of battery cells facing the second direction are connected by adhesive.

16. The vehicle battery pack according to claim 1, further comprising supporting side beams located on both sides, and the plurality of supporting beams are respectively connected to the plurality of supporting beams.

17. A vehicle battery pack, comprising:
a plurality of supporting beams extending in a first direction throughout the battery pack; and
a plurality of battery modules located between the supporting beams, the battery modules each including:
a base plate extending in the first direction throughout the battery pack, wherein the base plate includes a coolant circuit;
a plurality of battery cells that include side faces arranged relative to each other and connected to the base plate through adhesive; and
a plurality of end plates connected to the base plate, the plurality of end plates compressing the plurality of battery cells from both sides in the first direction, wherein, the plurality of battery cells include end faces facing a second direction, the end faces each adjacent to one of the supporting beams within the plurality of supporting beams.

18. The vehicle battery pack according to claim 17, wherein the plurality of supporting beams each include wing plates protruding from bottom to sides, the base plate supported on at least one of the wing plates.

19. The vehicle battery pack according to claim 17, wherein the plurality of supporting beams and the end faces of the plurality of battery cells facing the second direction are connected by adhesive.
